(19) United States
(12) Patent Application Publication
(10) Pub. No.: US 2023/0200609 A1
(43) Pub. Date: Jun. 29, 2023

(54) DUST COLLECTING DEVICE FOR A POWER TOOL

(71) Applicant: Hilti Aktiengesellschaft, Schaan (LI)

(72) Inventor: Uto PLANK, Freising (DE)

(21) Appl. No.: 17/927,948

(22) PCT Filed: Jun. 8, 2021
(86) PCT No.: PCT/EP2021/065239

§ 371 Date: Nov. 28, 2022

(30) Foreign Application Priority Data
Jun. 18, 2020 (EP) 20180782.3

(51) Int. Cl. A47L 9/20; A47L 7/00; A47L 9/14; A47L 9/12; B01D 46/76; B01D 46/12

(52) U.S. Cl. CPC A47L 9/20; A47L 7/0095; A47L 9/1409; A47L 9/122; B01D 46/76; B01D 46/12; B25D 17/20

(57) ABSTRACT

A dust collecting device for a power tool, the dust collecting device having a lamella filter and a rotatable shaft. In the collecting container of the dust collecting device, the lamellae of the filter can be set in an axial movement by a rotary movement of the shaft which is interrupted when the filter lamellae arrive in the region of release of the shaft. The release enables the lamellae to return to their original position, the return of the lamellae to this original position causing the lamellae to vibrate, which leads to the filter being cleaned. A power tool which has a proposed dust collecting device, as well as a method for operating a power tool and for cleaning a filter is also provided.

The present invention relates to a dust collecting device for a power tool, the dust collecting device having a lamella filter and a rotatable shaft. In further aspects, the invention relates to a power tool which has a proposed dust collecting device, as well as a method for operating a power tool and for cleaning a filter.

### BACKGROUND

Power tools are known in the prior art in which dust that arises when working with the power tool can be extracted by means of an internal dust extraction system. The collected dust can for example be caught in a dust collecting device inside the power tool or collected until the device is emptied. The power tool with dust extraction system can have filters, in particular miniature filters, in order to separate rock and/or dust particles from the air stream. These filters are often filters that have lamellae. In the context of the invention, these are preferably referred to as “lamella filters”. Experience has shown that these filters can easily become clogged with dust or coarse dirt, which can disadvantageously lead to the dust extraction system losing performance or clogging of the extraction channels. In particular, the undesired clogging of the filter can mean that a filling capacity of the dust collecting device cannot be used optimally.

### SUMMARY OF THE INVENTION

Various methods are known in the prior art with which a filter in a dust collecting device of a power tool can be cleaned. Most of these processes are mechanical cleaning processes that have a number of disadvantages. For example, it is proposed in the prior art to sweep the lamellae of the filter in order to clean the filter. However, it can happen that the sweeping device used for this can no longer move when the collecting device is filled with dust. This can disadvantageously impair the functionality of the filter cleaning system. Furthermore, damage to individual components of the dust collecting device can occur if the dust box is partially or completely filled with dust. In the prior art, for example, scrapers, slides or brushes are known as sweeping devices.

Furthermore, the prior art proposes knocking the entire dust collecting device. However, this knocking of the entire dust box often leads to mechanical impairment of the dust collecting device or its components. In the known solutions, knocking the dust collecting device mainly acts on the housing of the collecting container and often does not lead to sufficient cleaning of the filter.

Another cleaning option, which is known from the prior art, is to “blow off” the filter using a reverse air stream. The direction of flow of the suction air stream is in this case reversed by switching off or reducing the negative pressure, so that an air stream flows through the filter for a brief moment, the direction of which is opposite to the usual flow direction in the case of suction. However, it has been shown that the filter cleaning by a reverse air stream does not help or lead to the desired effect in particular when larger lumps of dust or rocks are jammed in the flow channel. This is typically because the reverse air stream is usually not strong enough to loosen or free jammed lumps of dust or rocks from the flow channel. Another disadvantage of cleaning by means of a reverse air stream is that the dust extraction must also be interrupted at the moment when the negative pressure is interrupted. During this cleaning period, the user of the power tool is exposed to the full amount of dust that occurs when working with the power tool.

It is a concern of the present invention to provide a device for improved cleaning of the filter in a dust collecting device. In addition, the invention is intended to specify a power tool with a dust collecting device to be provided, as well as a method for operating a power tool or a method for cleaning a filter in a dust collecting device in a power tool. The invention is intended to overcome the disadvantages and deficiencies of the prior art described above and, in particular, to enable efficient and effective cleaning of the filter in a dust collecting device of a power tool. The cleaning should be sufficiently strong to free, for example, lumps of dust or rocks that are jammed in a flow channel of the power tool. It would be welcomed by those skilled in the art if any mechanical stress associated with cleaning were limited to the region of the filter and surrounding components and, in particular, did not act on the housing. In addition, it should be possible with the invention to dispense with the use of inflexible and/or maintenance-prone sweeping devices.

The present invention provides a dust collecting device for a power tool, the dust collecting device having a collecting container for receiving the dust. The dust collecting device is characterized in that a filter with lamellae and a rotatable shaft are arranged in the collecting container, the lamellae of the filter being able to be set in an axial movement from an original position by a rotary movement of the shaft, the shaft having release means which enable the lamellae to return to their original position, the filter being cleaned by the return of the lamellae to their original position. In this respect, the invention presents a cleaning option for a lamella filter, with the lamella filter being able to filter a dust-laden air stream in a power tool. Due to the compact, mechanical and easy-to-use construction, the invention advantageously provides a particularly robust and low-maintenance dust box for a power tool. Tests have shown that the invention represents a cost-effective technical solution for filter cleaning, which in particular manages without a special sweeping device, knocking the entire dust box or a reverse blast of air. The proposed dust collecting device thus turns away from such solutions which are known from the prior art and breaks new ground in the area of cleaning a filter in a dust collecting device in a power tool.

It is preferred in the context of the invention that the shaft and the filter or its lamellae are in form-fitting engagement with one another. By this at least temporary contact between the lamellae of the filter and the rotatable shaft, the rotary movement of the shaft can be converted into an axial movement of the filter or the filter lamellae. The axial movement preferably takes place substantially parallel to a central axis of the shaft. The term “substantially parallel” is not an unclear term for a person skilled in the art, because a person skilled in the art knows that the formulation means a movement of the filter lamellae substantially parallel to an axial direction of the shaft, with minor deviations from the exact mathematical parallelism being tolerable.

It is very particularly preferred in the context of the invention that the shaft has a preferably helically profiled screw surface or a thread, the screw surface being able to come into engagement with the lamellae of the filter. It is preferred in the context of the invention that the presence of the helically formed screw surface or of the thread on the shaft can be otherwise expressed by saying that the shaft has turns. The contact between the screw surface of the shaft and the lamellae of the filter allow the lamellae to be moved in the axial direction of the shaft when the shaft rotates. The shaft is preferably arranged substantially horizontally in the collecting container of the power tool and can be set in rotation from the outside using a rotary grip. This rotation represents that rotary movement of the shaft with which the lamellae of the filter can be set in an axial movement. In particular, the individual lamellae of the filter can be carried along by the turns of the shaft, so that the rotational movement of the shaft is converted into an axial movement of the individual lamellae of the filter. The rotary handle can for example be fastened to the shaft with a fastening means such as a screw. In particular, the proposed dust collecting device can have a housing, wherein the rotary handle can be rotatably mounted, for example, in a recess in the housing. The housing can consist of two component halves which can be joined together to form the overall housing of the dust collecting device. The housing or its two component halves advantageously form or enclose a closed hollow or interior space in which the dust that is generated when a power tool is in operation can be collected. The proposed dust collecting device can in particular be designed as a component of a power tool. In the context of the invention, the proposed dust collecting device can preferably be referred to as a “dust box” or as a “dust removal module”.

If dust arises during operation of the power tool, this dust can be extracted by means of a dust extraction system, which can also be part of the power tool. For this purpose, the dust extraction system can generate a negative pressure with which an air stream can be generated with which the dust can be removed from a work area of the power tool. The dust-laden air stream is preferably guided in the direction of the dust collecting device. The dust collecting device preferably has an opening through which the air stream can enter the dust collecting device. It is preferred in the context of the invention that the filter is present in this opening or inlet region of the dust collecting device. It can happen that the filter becomes clogged if the power tool is in operation for a long time or if the air stream is very dust-laden. In this case, for example, a solid filter cake forms, which can lead to the extraction system losing suction power and clogging the suction channels. In addition, the filter becoming clogged may possibly result in the capacity of the dust collecting device or its collecting container not being used optimally.

Advantageously, the invention can provide a possibility for quick and effective cleaning of the filter. It is preferred in the context of the invention that the cleaning process is started by actuating a rotary handle of the dust collecting device. By actuating the rotary handle, the shaft is preferably set in rotation within the collecting container of the dust collecting device. It is preferred in the context of the invention that the shaft has screw surfaces which can come into engagement with lamellae of the filter or with the free spaces between the filter lamellae. By virtue of the configuration of the shaft with screw surfaces, the shaft can, in the context of the invention, preferably also be referred to as a conveying shaft or screw shaft. In other words, it is preferred in the context of the invention that the shaft takes the form of a screw shaft and has turns. It is preferred in the context of the invention that the rotary movement of the shaft can be converted into an axial movement of the lamellae of the filter. This occurs in particular by virtue of the fact that the turns of the shaft can be in form-fitting engagement with the lamellae of the filter or with the free spaces between the filter lamellae. In other words, the turns can engage in spaces between the filter lamellae, with the result that, during a repeated rotation of the shaft, the lamellae are driven or guided along by the turns thereof. In the context of the invention, this driving-along of the lamellae is referred to as “axial movement”. The axial movement is illustrated as a double arrow in FIG. 1.

Before the start of the rotary movement, the lamellae are in an original or starting position with respect to the shaft or the turns thereof. As a result of the axial movement, the filter lamellae are moved out of their starting position, in particular along an axial direction of the shaft. For example, due to their axial movement in the lateral direction, the lamellae can move by a length d to the right or left. The length d then preferably represents the distance between a lamella and its starting position. It is preferred in the context of the invention that each lamella has its own original position. For example, the shaft can have three to ten turns. It has been shown that shafts with five turns are particularly well suited for the purposes of the invention. It is preferred in the context of the invention that the number of turns of the shaft correlates with a number of lamellae of the filter. In the context of the invention, this correlation can mean that the number of turns of the shaft is the same as the number of lamellae of the filter. In the context of the invention, however, it is very particularly preferred that the number of lamellae of the filter is 1 greater than the number of turns of the shaft. This advantageously makes it possible for each shaft turn to engage in a space between the filter lamellae and to carry the lamella along with it during the rotary movement of the shaft. This preferably generates the axial movement of the shaft, which causes the filter to spring back and be cleaned. In other words, it can be preferred in the context of the invention that the shaft has a number of n turns and the filter has a number of n+1 lamellae. It is very particularly preferred in the context of the invention that a thread pitch of the shaft corresponds to a distance separating the lamellae.

It is preferred in the context of the invention that the shaft comprises release means. These release means can take the form of flats. In other words, the shaft can have flats as release means. Preferably, the flats can take the form of surface regions which are flat or planar in form, with preferably one flat being provided for each turn of the shaft. One possible embodiment of the shaft with release means taking the form of flats is illustrated in FIG. 3. In particular, the flats can outwardly close off the turns in a subregion of the turn. It is preferred in the context of the invention that the lamellae of the filter return to their original position when the flats of the shaft are situated above the lamellae of the filter. This preferably means in the context of the invention that the driving-along of the lamellae ends in the region of the flats and the lamellae can spring back or snap back into their original starting situation, since they are no longer held by the flats which are preferably planar in form. The springing back or snapback preferably causes the filter lamellae to be vibrated, whereby the dust or filter cake can be loosened and/or shaken off the lamellae. In particular, the vibration enables effective and efficient cleaning of the filter lamellae or the filter.

It is preferred in the context of the invention that the lamellae of the filter are released from the shaft or its turns when the lamellae arrive in the region of the flats of the shaft. The release allows the lamellae to spring back or snap back into their earlier position. This in most cases jerky movement then advantageously leads to a vibration of the lamellae, through which the dust or the filter cake can loosen in the clogged or blocked-up filter. In particular, a cleaning effect is brought about by the advantageous interaction of the rotatable shaft and the filter.

It is preferred in the context of the invention that the collecting container has a rotary handle with which the shaft can be set in rotation. In other words, it is preferred in the context of the invention that the rotary handle is designed to set the shaft in rotation. This rotary movement can in particular take place by a preferably manual actuation by the user of the power tool. In an alternative embodiment of the invention, it can also be preferred that the shaft is driven by drive means. For this purpose, an electric motor can be provided that can be activated or deactivated with a switch. In the alternative embodiment of the invention, this switch can be arranged in the region on the housing of the dust collecting device in which the rotary handle is provided in the “manual embodiment” of the invention. For ergonomic reasons, however, the switch can also be arranged at various other locations.

The invention is preferably situated within the technical field of dust removal from a work area of a power tool. The work area of the power tool preferably represents that area in which the work to be carried out with the power tool is performed. This is mostly done with the help of a tool. If the power tool is, for example, a hammer drill, the tool can be formed, for example, by a drilling or chiseling tool. The area in which the drilling or chiseling tool, as a tool of the power tool, comes into contact with a substrate to be machined is preferably referred to as the “working area of the power tool” in the context of the invention. In the context of the invention, it is preferred that the dust that is preferably to be collected by means of the present invention is generated in this work area. For this purpose, the power tool can include a dust extraction system. It is preferred in the context of the invention that the dust extraction system is a device that is designed to generate an air stream or a negative pressure and to suck off the dust that can arise in the working area of the power tool during its operation, with the air stream.

The invention relates in a second aspect to a power tool with a dust extraction system for removing particles from a work area of the power tool. In particular, it is provided that the power tool has a proposed dust collecting device. The power tool is characterized in that a filter with lamellae and a rotatable shaft are arranged in the collecting container of the dust collecting device, the lamellae of the filter being able to be set in a movement from an original position by a rotary movement of the shaft, the shaft having release means which are designed to enable the lamellae to return to their original position, the return of the lamellae to their original position causing the lamellae to vibrate. It represents a significant advantage of the proposed dust collecting device that this vibration leads to the filter being cleaned.

It is preferred in the context of the invention that the power tool comprises a dust extraction system, the dust extraction system being designed to generate an air stream with which dust is removed. The dust extraction system is used in particular to allow the dust to be extracted from the work area of the power tool. For this purpose, the dust extraction system of the power tool is preferably designed to generate a negative pressure, which in turn generates an air stream. With this air stream, the dust can be removed from the working area of the power tool and guided in the direction of the dust collecting device. A flow channel for the air stream is preferably provided in the power tool, through which channel the air stream is guided from the work area to the dust collecting device. The dust that arises during operation of the power tool can preferably be collected in a collecting container of the dust collecting device. When entering the dust collecting device, it is preferred in the context of the invention that the air stream is filtered. For this purpose, a filter can be provided in the inlet region of the dust collecting device or the collecting container of the dust collecting device. The filter has lamellae, with a key merit of the lamellae being to enlarge the surface of the filter and thus to increase the filter performance of the filter. This allows the air stream to be filtered particularly effectively and freed of relatively coarse dust particles.

It is very particularly preferred in the context of the invention that the filter is designed to filter out dust and/or dust particles from an air stream leading into the collecting container of the proposed dust collecting device. In other words, it is preferred in the context of the invention that the filter is present at the inlet region of the collecting container, the air stream in this inlet region preferably opening into the collecting container. The inlet region of the collecting container preferably represents that region of the collecting container in which the air stream enters the collecting container and is still fully laden with dust, particles and/or pieces of rock. By filtering these relatively coarse dust particles out of the air stream, the functionality of the proposed dust collecting device can be improved and its service life can be extended.

In a further aspect, the invention relates to a method for operating a power tool and for cleaning a filter. The method is characterized by the following method steps:
a) operation of the proposed power tool, wherein dust that arises during operation of the power tool is removed by means of an air stream,
b) filtering of the dust from the air stream,
c) initiation of the cleaning of the filter by actuating a rotary handle on the dust collecting device, wherein a shaft within the dust collecting device is set in rotation by actuating the rotary handle,
d) conversion of the rotary movement of the shaft into an axial movement of lamellae of the filter, the lamellae of the filter leaving an original position due to the axial movement,
e) return of the lamellae of the filter to their original position when the lamellae arrive in a region of release means of the shaft,
f) cleaning of the filter by returning the lamellae to their original position.

In the context of the proposed filter cleaning method, it is preferred that the dust can be sucked out of a work area of the power tool by a dust extraction system of the power tool. This is achieved in particular in that an air stream is generated by the dust extraction system, with which the dust can be removed from the work area of the power tool. The dust is preferably collected in the collecting container of the dust collecting device, the air stream passing through a filter when it enters the collecting container. It can happen that the filter becomes clogged if the power tool is in operation for a long time or if the air stream is very dust-laden. For example, a so-called filter cake can form in the filter. In this situation, the invention advantageously makes it possible to initiate cleaning of the filter, the filter cleaning being started in particular by actuating a rotary handle on an outer side of the dust collecting device. For example, the rotary handle can be rotatably mounted in a recess in the housing.

In the context of the invention, it is preferred that the shaft is set in rotation within the dust collecting device by actuating the rotary handle. The shaft, which preferably takes the form of a screw shaft, can have turns, the turns preferably being able to come into engagement with the lamellae of the filter. In other words, the screw shaft can be in form-fitting engagement with the filter lamellae, the form-fitting engagement being in particular between the turns of the shaft and the lamellae of the filter. It is preferred in the context of the invention that a rotary movement of the shaft is converted into an axial movement of the lamellae of the filter, the lamellae of the filter leaving their original position as a result of the axial movement. It is an essential feature of the invention that the shaft has release means which allow the lamellae of the filter to return to their original position when the filter lamellae arrive in a region of the release means. This is the case in particular when the release means or flats of the shaft are located above the lamellae of the filter. The filter can advantageously be cleaned by vibrating the lamellae of the filter, the vibration being caused by the return of the lamellae to their original position.

The definitions, technical effects and advantages that have been described for the proposed dust collection device apply analogously to the operating and cleaning process as well as to the power tool.

### BRIEF DESCRIPTION OF THE DRAWINGS

Further advantages of the invention will become apparent from the following description of the figures. The figure shows an exemplary embodiment of the present invention. The figure, the description and the claims contain numerous features in combination. A person skilled in the art will expediently also consider the features individually and combine them to form useful further combinations.

In the figures, identical and similar components are denoted by the same reference signs. In the drawing:

FIG. 1 shows a view of a preferred embodiment of the proposed dust collecting device (exploded drawing),

FIG. 2 shows a view of a preferred embodiment of the proposed dust collecting device in the closed state,

FIG. 3 shows a view of a preferred embodiment of the shaft having turns and release means.

### DETAILED DESCRIPTION

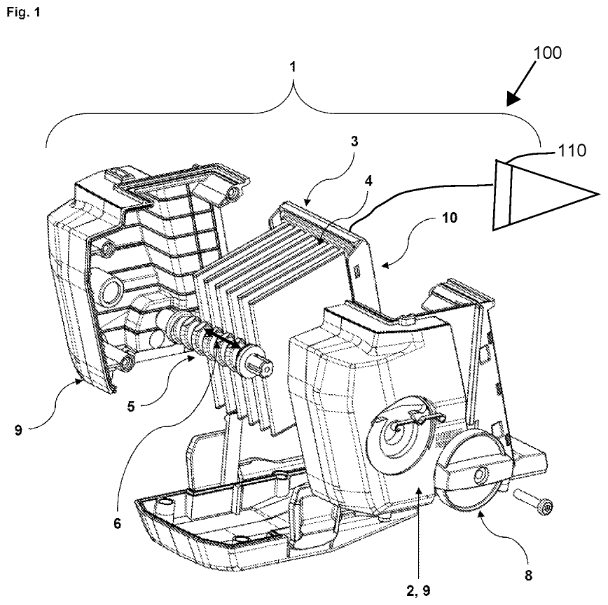

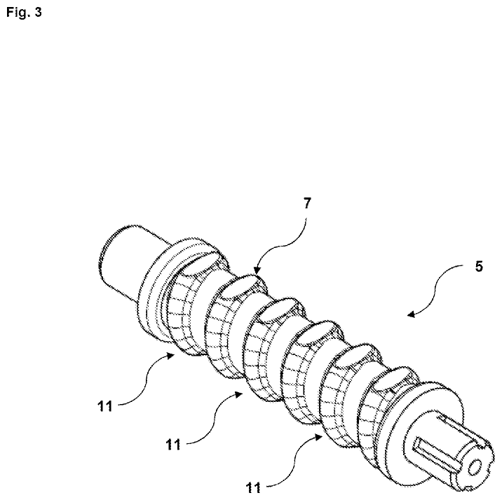

FIG. 1 shows the view of a preferred embodiment of the proposed dust collecting device (1). In particular, FIG. 1 shows an exploded drawing of the dust collecting device (1). From top left to bottom right, FIG. 1 shows a first half of the housing (9) of the dust collecting device (1) or the collecting container (2), the filter (3) and its lamellae (4), as well as the shaft (5) with the release means (7)(see, e.g., FIG. 3), a second half of the housing (9) of the dust collecting device (1) or the collecting container (2), and the rotary handle (8).

It is preferred in the context of the invention that the two component halves of the housing (9) enclose a volume of space, wherein dust can be captured and collected in this closed volume of space. In this respect, the two component halves of the housing (9) preferably form the collecting container (2) of the dust collecting device (1). The lower region of the collecting container (2) can be formed by a base or a shell. A front side of the dust collecting device (1), in which a filter (3) can be arranged, can extend starting from this underside of the collecting container (2). In the context of the invention, it is preferred that the front side of the dust collecting device (1) forms the inlet region (10) of the dust collecting device (1) into which the dust-laden air stream opens. In particular, the filter (3) can be arranged in a filter receptacle. The filter (3) is preferably a lamella filter, that is to say preferably a filter (3) which has lamellae (4). In the exemplary embodiment of the invention shown in FIG. 1, the filter (3) has, for example, six lamellae (4), with five spaces between the lamellae (4). In the context of the invention, it is preferred that the turns (11) of a shaft (5) (see, e.g., FIG. 3) can engage in the free spaces between the lamellae (4) of the filter (3).

The two component halves of the housing (9) can have openings for receiving this shaft (5). In particular, the shaft (5) can be rotatably mounted within the dust collecting device (1), with the shaft (5) being able to be set in rotation in particular by means of a rotary handle (8). The rotary handle (8) can, for example, be accessible from the outside and manually actuated by a user of the power tool (shown solely schematically as 100 with dust extraction system 110). For this purpose, the user can in particular turn the rotary handle (8). The rotary handle (8) is preferably rotatably mounted within the housing (9) of the dust collecting device (1). For this purpose, the housing (9) or one of its component halves can have a recess for receiving the rotary handle (8). The rotary handle (8) is advantageously easily accessible from outside the dust collecting device (1).

By actuating the rotary handle (8), the shaft (5) is set in a rotary movement. If the turns (11) of the shaft (5) are in form-fitting engagement with the lamellae (4) of the filter (3) or with the free spaces between the lamellae (4) of the filter (3), the turns (11) of the shaft (5) drive along the lamellae (4) when the shaft (5) rotates. Before the lamellae (4) are driven along by the turns (11), the filter lamellae (4) are preferably in a starting or original position. The driving of the filter lamellae (4) by the turns (11) generates an axial movement (6) of the lamellae (4) of the filter (3), which is shown in FIG. 1 as a double arrow. The double arrow indicates that the lamellae (4) of the filter (3) can move, for example, in the direction of the first component half of the housing (9) of the dust collecting device (1) when they are driven along by the turns (11) of the shaft (5). The axial movement (6) of the filter lamellae (4) preferably takes place substantially parallel to a central axis, which runs through the shaft (5) as an imaginary axis. In the context of the invention, it is preferred that the driving of the filter lamellae (4) ends when the lamellae (4) of the filter (3) arrive in the region of the release means (7) of the shaft (5). The release means (7) can be, for example, planar surfaces at the highest point of a turn (11) of the shaft (5). Preferably, each turn (11) of the shaft (5) has such a planar surface, with, in the context of the invention, these planar surfaces preferably being referred to as flats. When the flats (7) of the shaft (5) are situated above the lamellae (4) of the filter (3), the filter lamellae (4) are released. In the context of the invention, this preferably means that the lamellae (4) of the filter (3) can spring back into their starting position. This return movement of the filter lamellae (4) can take place, for example, in the direction of the second component half of the housing (9) of the dust collecting device (1), with this snapback of the lamellae (4) of the filter (3) being able to cause that vibration that advantageously leads to dust and filter cake being released from the lamellae (4) and the filter (3) being cleaned. In other words, when the filter lamellae (4) spring back into their starting position, the filter lamellae (4) may in particular vibrate, releasing dust and filter cake from the filter (3). The released dust or filter cake can fall into the collecting container (2) of the dust collecting device (1) and be disposed of when the collecting container (2) is next emptied.

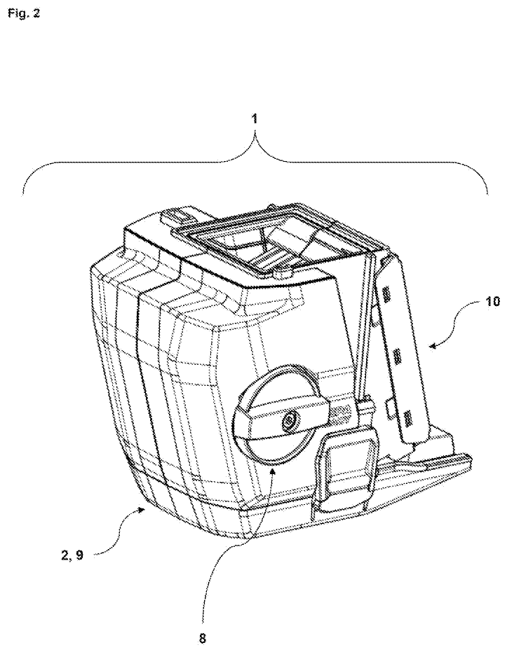

FIG. 2 shows the view of a preferred embodiment of the proposed dust collecting device (1) in a closed state. In particular, the two component halves of the housing (9) of the dust collecting device (1) are connected to one another such that they form the closed collecting container (2) which is designed to receive dust and the like. In the exemplary embodiment of the invention that is illustrated in FIG. 2, there can also be seen the rotary handle (8) which is present in the second component half of the housing (9) of the dust collecting device (1).

FIG. 3 shows a view of a preferred embodiment of the shaft (5) with turns (11) and release means (7). The shaft (5) depicted in FIG. 3 has, in particular, five turns (11) which can come into engagement or interact with the spaces between the filter lamellae (4) in order to convert a rotary movement of the shaft (5) into an axial movement (6) of the lamellae (4). Clearly visible in FIG. 3 are also the release means (7) which, in the exemplary embodiment of the invention that is illustrated in FIG. 3, particularly take the form of flats. In particular, in FIG. 3, the first, third and fifth turn (11) of the shaft (5) are provided with an arrow and a reference sign 11. In the context of the invention, these turns (11) can preferably also be referred to as thread turns.

### LIST OF REFERENCE SIGNS

1 Dust collecting device

2 Collecting container

3 Filter

4 Lamellae

5 Shaft

6 Axial movement

7 Release means

8 Rotary handle

9 Housing

10 Inlet region

11 Turns

100 Power tool

110 Dust Extractor

1-10. (canceled)

11. A dust collecting device for a power tool, the dust collecting device comprising:
a collecting container for receiving dust;
a filter with lamellae and a rotatable shaft arranged in the collecting container, the lamellae of the filter axially moveable out of an original position by a rotary movement of the shaft, the shaft having a release enabling the lamellae to return to the original position, the filter being cleaned by the return of the lamellae to the original position.

12. The dust collecting device as recited in claim 11 wherein the shaft is a screw shaft and has turns.

13. The dust collecting device as recited in claim 11 wherein the release includes flats.

14. The dust collecting device as recited in claim 11 wherein the collecting container has a rotary handle, the rotary handle being designed to set the shaft in rotation.

15. The dust collecting device as recited in claim 14 wherein the rotary handle is present in a housing of the collecting container.

16. The dust collecting device as recited in claim 11 wherein the filter is arranged in an inlet region of the collecting container of the dust collecting device.

17. A power tool comprising the dust collecting device as recited in claim 11.

18. The power tool as recited in claim 17 further comprising a dust extractor designed to generate an air stream containing dust.

19. A method for operating a power tool and for cleaning a filter, the method comprising:
a) operating the power tool as recited in claim 17, wherein the dust that arises during operation of the power tool is removed by means of the air stream,
b) filtering of the dust from the air stream with a filter,
c) initiating cleaning of the filter by actuating a rotary handle on the dust collecting device, wherein the shaft within the dust collecting device is set in rotation by actuating the rotary handle,
d) converting the rotary movement of the shaft into an axial movement of the lamellae of the filter, the lamellae of the filter leaving the original position due to the axial movement,
e) returning the lamellae of the filter to the original position when the lamellae arrive in a region of the release of the shaft,
f) cleaning the filter by returning the lamellae to the original position.

20. The method as recited in claim 19 wherein the dust arising during operation of the power tool is collected in the collecting container of the dust collecting device.
